(19) United States
(12) Patent Application Publication
(10) Pub. No.: US 2025/0150854 A1
(43) Pub. Date: May 8, 2025

(54) MEASUREMENT METHOD AND APPARATUS

(71) Applicant: Beijing Xiaomi Mobile Software Co., Ltd., Beijing (CN)

(72) Inventor: Xuhua TAO, Beijing (CN)

(21) Appl. No.: 18/838,557

(22) PCT Filed: Feb. 21, 2022
(86) PCT No.: PCT/CN2022/077135

§ 371 Date: Aug. 14, 2024

(51) Int. Cl. H04W 24/02; H04W 8/22; H04W 36/00

(52) U.S. Cl. CPC H04W 24/02; H04W 8/22; H04W 36/0085

(57) ABSTRACT

A measurement method includes: reporting capability indication information of a terminal device to a network side device, where the capability indication information is configured to indicate that the terminal device supports the simultaneous configuration of N measurement Gaps, and N is a positive integer; receiving configuration information sent by the network side device, where the configuration information is configured according to the capability indication information, and the configuration information includes M measurement gap configurations, where M is a positive integer less than or equal to N; receiving first indication information sent by the network side device, where the first indication information is configured to indicate that the terminal device performs mobility measurement; and performing the mobility measurement according to the first indication information and the configuration information.

### CROSS-REFERENCE TO RELATED APPLICATIONS

The present application is a U.S. National Stage of International Application No. PCT/CN2022/077135, entitled “MEASUREMENT METHOD AND APPARATUS”, filed on Feb. 21, 2022, the contents of all of which are incorporated herein by reference in their entireties for all purposes.

### BACKGROUND

In a non-terrestrial network (NTN) system, when a network side device (for example, a satellite) serves a plurality of coverage cells (foot points) on the ground through multi-beam, different foot points may correspond to different frequency domain resources.

In these scenarios, how the network side device configures measurement resources for a terminal device is an urgent problem to be solved.

### SUMMARY

The disclosure relates to the technical field of communication, in particular to a measurement method and apparatus.

In a first aspect, an example of the disclosure provides a measurement method, and the measurement method is applied to the terminal device and includes: reporting capability indication information of the terminal device to a network side device, where the capability indication information is configured to indicate that the terminal device supports simultaneous configuration of N measurement Gaps, and N is a positive integer; receiving configuration information sent by the network side device, where the configuration information is configured by the network side device according to the capability indication information, and the configuration information includes M measurement Gap configurations, where M is a positive integer less than or equal to N; receiving first indication information sent by the network side device, where the first indication information is configured to indicate that the terminal device performs mobility measurement; and performing the mobility measurement according to the first indication information and the configuration information.

In a second aspect, an example of the disclosure provides another measurement method, and the measurement method is applied to the network side device and includes: receiving capability indication information reported by a terminal device, where the capability indication information indicates that the terminal device supports simultaneous configuration of N measurement Gaps, and N is a positive integer; sending configuration information to the terminal device, where the configuration information is configured by the network side device according to the capability indication information, and the configuration information includes M measurement Gap configurations, where M is a positive integer less than or equal to N; and sending first indication information to the terminal device, where the first indication information is configured to indicate that the terminal device performs mobility measurement.

In a third aspect, an example of the disclosure provides a communication apparatus. The communication apparatus has part or all of the functions of the terminal device for implementing the measurement method described in the first aspect above. For example, the functions of the communication apparatus may have functions in part or all of the examples in the disclosure, or may have the functions of implementing any one of the examples separately in the disclosure. The functions may be implemented by hardware, or may be implemented by executing corresponding software through hardware. The hardware or software includes one or more units or modules corresponding to the above functions.

In an implementation, the communication apparatus includes: a sending module, configured to send capability indication information of a terminal device to a network side device, where the capability indication information is configured to indicate that the terminal device supports simultaneous configuration of N measurement Gaps, and N is a positive integer; a receiving module, configured to receive configuration information sent by the network side device, where the configuration information is configured by the network side device according to the capability indication information, and the configuration information includes M measurement Gap configurations, where M is a positive integer less than or equal to N; the receiving module, further configured to receive first indication information sent by the network side device, where the first indication information is configured to indicate that the terminal device performs mobility measurement; and a processing module, configured to perform the mobility measurement according to the first indication information and the configuration information.

In a fourth aspect, an example of the disclosure provides another communication apparatus. The communication apparatus has part or all of the functions of the network side device for implementing the measurement method examples described in the second aspect above. For example, the functions of the communication apparatus may have functions in part or all of the examples in the disclosure, or may have the functions of implementing any one of the examples separately in the disclosure. The functions may be implemented by hardware, or may be implemented by executing corresponding software through hardware. The hardware or software includes one or more units or modules corresponding to the above functions.

In an implementation, the communication apparatus includes: a receiving module, configured to receive capability indication information reported by a terminal device, where the capability indication information indicates that the terminal device supports simultaneous configuration of N measurement Gaps, and N is a positive integer; a sending module, configured to send configuration information to the terminal device, where the configuration information is configured by the network side device according to the capability indication information, and the configuration information includes M measurement Gap configurations, where M is a positive integer less than or equal to N; and the sending module, further configured to send first indication information to the terminal device, where the first indication information is configured to indicate that the terminal device performs mobility measurement.

In a fifth aspect, an example of the disclosure provides a communication apparatus, the communication apparatus includes a processor, and the processor, when calling a computer program in a memory, executes the measurement method described in the first aspect above.

In a sixth aspect, an example of the disclosure provides a communication apparatus, the communication apparatus includes a processor, and the processor, when calling a computer program in a memory, executes the measurement method described in the second aspect above.

In a seventh aspect, an example of the disclosure provides a communication apparatus, the communication apparatus includes a processor and a memory, the memory stores a computer program. The processor executes the computer program stored in the memory to cause the communication apparatus implement the following steps: reporting capability indication information of the terminal device to a network side device, wherein the capability indication information is configured to indicate that the terminal device supports simultaneous configuration of N measurement Gaps, and N is a positive integer; receiving configuration information sent by the network side device, wherein the configuration information is configured by the network side device according to the capability indication information, and the configuration information comprises M measurement Gap configurations, wherein M is a positive integer less than or equal to N; receiving first indication information sent by the network side device, wherein the first indication information is configured to indicate that the terminal device performs mobility measurement; and performing the mobility measurement according to the first indication information and the configuration information.

In an eighth aspect, an example of the disclosure provides a communication apparatus, the communication apparatus includes a processor and a memory, the memory stores a computer program. The processor executes the computer program stored in the memory to cause the communication apparatus executes the measurement method described in the second aspect above.

In a ninth aspect, an example of the disclosure provides a communication apparatus, including a processor and an interface circuit. The interface circuit is configured to receive code instructions and transmitting the same to the processor, and the processor is configured to run the code instructions, such that the communication apparatus executes the measurement method described in the first aspect above.

In a tenth aspect, an example of the disclosure provides a communication apparatus, including a processor and an interface circuit. The interface circuit is configured to receive code instructions and transmitting the same to the processor, and the processor is configured to run the code instructions, such that the communication apparatus executes the measurement method described in the second aspect above.

In an eleventh aspect, an example of the disclosure provides a measurement system. The system includes the communication apparatus described in the third aspect and the communication apparatus described in the fourth aspect, or the system includes the communication apparatus described in the fifth aspect and the communication apparatus described in the sixth aspect, or the system includes the communication apparatus described in the seventh aspect and the communication apparatus described in the eighth aspect, or the system includes the communication apparatus described in the ninth aspect and the communication apparatus described in the tenth aspect.

In a twelfth aspect, an example of the disclosure provides a non-transitory computer readable storage medium for storing instructions used by the terminal device above. The instructions, when executed, causes the terminal device to execute the measurement method described in the first aspect above.

In a thirteenth aspect, an example of the disclosure provides a non-transitory computer readable storage medium for storing instructions used by the network side device above. The instructions, when executed, causes the network side device to execute the measurement method described in the second aspect above.

In a fourteenth aspect, the disclosure further provides a computer program product including a computer program. The computer program product, when running on a computer, causes the computer to execute the measurement method described in the first aspect above.

In a fifteenth aspect, the disclosure further provides a computer program product including a computer program. The computer program product, when running on a computer, causes the computer to execute the measurement method described in the second aspect above.

In a sixteenth aspect, the disclosure provides a chip system. The chip system includes at least one processor and an interface, for supporting the terminal device in implementing the functions involved in the first aspect, for example, determining or processing at least one of data and information involved in the above method. In one possible design, the chip system further includes a memory, and the memory is configured to store needful computer programs and data for the terminal device. The chip system may consist of chips, may also include a chip and other discrete devices.

In a seventeenth aspect, the disclosure provides a chip system. The chip system includes at least one processor and an interface, for supporting the network side device in implementing the functions involved in the second aspect, for example, determining or processing at least one of data and information involved in the above method. In one possible design, the chip system further includes a memory, and the memory is configured to store needful computer programs and data for the network side device. The chip system may consist of chips, may also include a chip and other discrete devices.

In an eighteenth aspect, the disclosure provides a computer program. The computer program, when running on a computer, causes the computer to execute the measurement method described in the first aspect above.

In a nineteenth aspect, the disclosure provides a computer program. The computer program, when running on a computer, causes the computer to execute the measurement method described in the second aspect above.

### BRIEF DESCRIPTION OF DRAWINGS

In order to more clearly illustrate technical solutions in examples of the disclosure or the background technology, accompanying drawings needing to be used in the examples of the disclosure or the background technology will be illustrated below.

FIG. 1 is an architecture diagram of a communication system provided by an example of the disclosure.

FIG. 2 is a flow diagram of a measurement method provided by an example of the disclosure.

FIG. 3 is a flow diagram of another measurement method provided by an example of the disclosure.

FIG. 4 is a flow diagram of yet another measurement method provided by an example of the disclosure.

FIG. 5 is a flow diagram of yet another measurement method provided by an example of the disclosure.

FIG. 6 is a flow diagram of yet another measurement method provided by an example of the disclosure.

FIG. 7 is a flow diagram of yet another measurement method provided by an example of the disclosure.

FIG. 8 is a flow diagram of yet another measurement method provided by an example of the disclosure.

FIG. 9 is a flow diagram of yet another measurement method provided by an example of the disclosure.

FIG. 10 is a flow diagram of yet another measurement method provided by an example of the disclosure.

FIG. 11 is a flow diagram of yet another measurement method provided by an example of the disclosure.

FIG. 12 is a flow diagram of yet another measurement method provided by an example of the disclosure.

FIG. 13 is a flow diagram of yet another measurement method provided by an example of the disclosure.

FIG. 14 is a structural diagram of a communication apparatus provided by an example of the disclosure.

FIG. 15 is a structural diagram of another communication apparatus provided by an example of the disclosure.

FIG. 16 is a structural diagram of yet another communication apparatus provided by an example of the disclosure.

FIG. 17 is a structural diagram of yet another communication apparatus provided by an example of the disclosure.

FIG. 18 is a structural diagram of yet another communication apparatus provided by an example of the disclosure.

FIG. 19 is a structural diagram of yet another communication apparatus provided by an example of the disclosure.

FIG. 20 is a structural diagram of yet another communication apparatus provided by an example of the disclosure.

FIG. 21 is a structural diagram of yet another communication apparatus provided by an example of the disclosure.

FIG. 22 is a schematic structural diagram of a chip provided by an example of the disclosure.

### DETAILED DESCRIPTION

Examples of the disclosure provide a measurement method and apparatus, so that the network side device configures suitable measurement resources for the terminal device to perform mobility measurement.

Unless otherwise defined, all technical and scientific terms used here have the same meaning as commonly understood by those skilled in the art belonging to the technical field of the disclosure. The terms used in the specification of the disclosure here are intended to describe the specific example and are not intended to limit the disclosure.

In order to better understand the examples of the disclosure, some related concepts will be introduced below.

### 1. NTN Technology

At present, the third generation partnership project (3GPP) is studying the NTN technology, and the NTN technology generally provides communication services for ground users in a manner of satellite communication. Compared with terrestrial cellular network communication, the satellite communication has many unique advantages. First, the satellite communication is not limited by a user's region, for example, general land communication cannot cover areas such as sea, high mountains, and desert where communication devices cannot be set up or communication coverage is not made due to population scarce. For the satellite communication, a satellite may cover a large ground surface, in addition, the satellite may make orbital motion around the earth, and thus every corner on the earth may be covered by the satellite communication theoretically. Second, the satellite communication has great social value. The satellite communication may be covered at a low cost in remote mountainous areas, and poor and backward countries or regions, so that people in these regions enjoy advanced speech communication and mobile Internet technology, which is conducive to narrowing a digital divide with developed regions and promoting the development of these regions. Third, the satellite communication has a long distance, and cost of communication is not significantly increased as the communication distance increases; and finally, the satellite communication has high stability and is not limited by natural disasters.

Communication satellites are divided into a low-earth orbit (LEO) satellite, a medium-earth orbit (MEO) satellite, a geostationary earth orbit (GEO) satellite, a high elliptical orbit (HEO) satellite, and so on according to different orbital altitudes. At a current stage, the main research focuses on the LEO and the GEO.

LEO: the low-earth orbit satellite has an altitude range of 500 km to 1500 km, with a corresponding orbital period of approximately 1.5 hours to 2 hours. A signal propagation delay of single-hop communication between users is generally less than 20 ms. A maximum satellite visibility time is 20 minutes. The signal propagation distance is short, the link loss is low, and the transmission power requirements for user terminals are not high.

GEO: the geostationary earth orbit satellite has an orbital altitude of 35786 km and a rotation period of 24 hours around the earth. A signal propagation delay of single-hop communication between users is generally 250 ms.

In order to ensure satellite coverage and improve a system capacity of an entire satellite communication system, the satellite adopts multi-beam to cover the ground. One satellite may form dozens or even hundreds of beams to cover the ground, and one satellite beam may cover ground areas with a diameter of dozens to hundreds of kilometers.

### 2. NR Measurement

Measurement mainly refers to mobility measurement in a connected state. After a network side device issues a measurement configuration to a terminal device, the terminal device detects a signal quality state of neighboring cells according to a measurement object, a reporting configuration, and other parameters indicated in the measurement configuration, and feeds measurement reporting information back to the network side device, so that the network side device switches or improves a relationship list of the neighboring cells.

### 1. Measurement Configuration

In NR, the network side device sends measurement configuration information to the terminal device in a connected state through a radio resource control (RRC) signaling, the terminal device performs measurement (intra-frequency, inter-frequency and inter-technology) according to content of the measurement configuration information, and then reports measurement results to the network side device.

The network side device uses RRC connection reconfiguration to perform measurement configuration, and the measurement configuration information includes the following contents:

### (1) Measurement Object (MO)

for intra-frequency measurement and inter-frequency measurement, each measurement object (MO) indicates a time-frequency position to be measured and a subcarrier spacing of a reference signal. The network side device may configure a cell offset list for cells related to the measurement object (MO).

For each measurement frequency point, a network configures an SSB based RRM measurement timing configuration (SMTC) for indicating a time for the terminal device to receive an SSB on a neighboring cell corresponding to the frequency point, and the SMTC configuration includes: a period of the SMTC, a start time offset of the SMTC within one period, a duration of the SMTC, and the like.

### (2) Measurement Gap

The measurement gap is configured to indicate a time for the terminal device to perform inter-frequency/inter-system measurement. The terminal device performs the inter-frequency/inter-system measurement during the measurement Gap. A measurement Gap configuration includes: a period of the measurement Gap, a start time offset of the measurement Gap within one period, a duration of the measurement Gap, and the like.

In a current NR standard, the measurement Gap is configured based on the terminal device, and the SMTC is configured based on the frequency point.

Compared with a cellular network adopted by a traditional NR, signal propagation delay between the terminal device and a cell satellite in the NTN is greatly increased. In addition, because a coverage range of the cell satellite is very large, the signal propagation delay between the terminal device and different cell satellites is also greatly different.

In order to better understand a measurement method and apparatus disclosed in the examples of the disclosure, the following will first describe a communication system applicable to the examples of the disclosure.

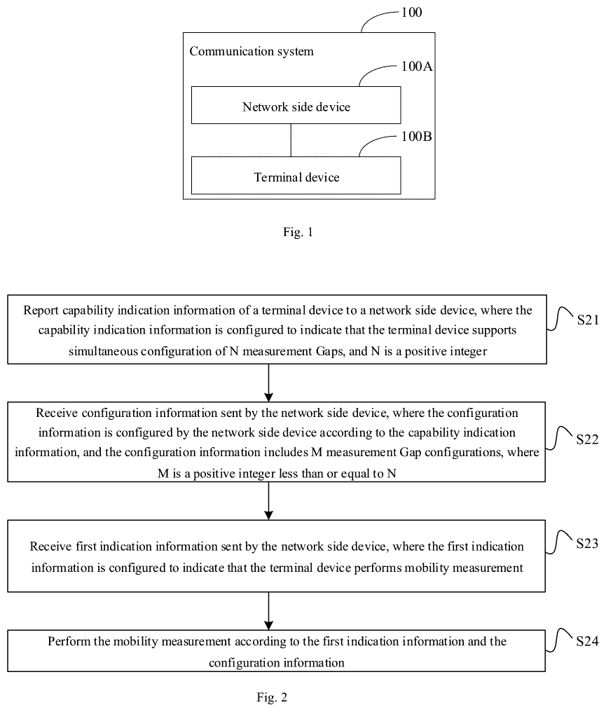

Please refer to FIG. 1, and FIG. 1 is an architecture diagram of a communication system 100 provided by an example of the disclosure. The communication system 100 may include, but is not limited to one network side device 100A and one terminal device 100B. The number and form of devices shown in FIG. 1 are for example and do not constitute a limitation on the examples of the disclosure. In practical applications, it may include two or more network side devices and two or more terminal devices. The communication system shown in FIG. 1 includes one network side device 100A and one terminal device 100B as an example.

It is to be noted that the technical solutions of the examples of the disclosure may be applied to various communication systems, such as a global system of mobile communication (GSM) system, a code division multiple access (CDMA) system, a wideband code division multiple access (WCDMA) system, a general packet radio service (GPRS), a long term evolution (LTE) system, an LTE frequency division duplex (FDD) system, an LTE time division duplex (TDD) system, an advanced long term evolution (LTE-A) system, a new radio (NR) system, an evolution system of the NR system, an LTE-based access to unlicensed spectrum (LTE-U) system, an NR-based access to unlicensed spectrum (NR-U) system, a universal mobile telecommunication system (UMTS), a worldwide interoperability for microwave access (WiMAX) communication system, wireless local area networks (WLAN), wireless fidelity (WiFi), a next-generation communication system or other communication systems.

The network side device 100A in the examples of the disclosure is an entity on a network side for transmitting or receiving a signal. For example, the network side device 100A may be an evolved NodeB (eNB), a transmission reception point (TRP), a next generation NodeB (gNB) in the NR system, network side devices in other future mobile communication systems, or an access node in a wireless fidelity (WiFi) system, etc. A specific technology and a specific device form adopted by the network side device are not limited by the examples of the disclosure. The network side device provided by the examples of the disclosure may be composed of a central unit (CU) and a distributed unit (DU), where the CU may also be referred to as a control unit. A CU-DU structure may be used to separate the network side device, such as a protocol layer of the network side device, with functions of some protocol layers placed in the CU for centralized control, and functions of the remaining or all protocol layers distributed in the DU, and the DU being centrally controlled by the CU.

The terminal device 100B in the examples of the disclosure is an entity on a user side for receiving or transmitting a signal, such as a mobile phone. The terminal device may also be referred to as a terminal, user equipment (UE), a mobile station (MS), a mobile terminal (MT), etc. The terminal device may be a car with a communication function, a smart car, a mobile phone, a wearable device, a tablet computer (Pad), a computer with a wireless transceiving function, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, a wireless terminal device in a smart home and the like. A specific technology and a specific device form adopted by the terminal device are not limited by the examples of the disclosure.

It may be understood that the communication system described by the examples of the disclosure is for the purpose of illustrating the technical solutions of the examples of the disclosure more clearly, and does not constitute a limitation to the technical solutions provided by the examples of the disclosure. Those ordinarily skilled in the art may know that with evolution of the system architecture and occurrence of a new business scenario, the technical solutions provided by the examples of the disclosure are also applicable to the similar technical problem.

A measurement method and apparatus provided by the disclosure will be described in detail below with reference to the accompanying drawings.

Please refer to FIG. 2, and FIG. 2 is a flow diagram of a measurement method provided by an example of the disclosure.

As shown in FIG. 2, the measurement method is executed by a terminal device, and may include, but is not limited to the following steps:

S21: capability indication information of the terminal device is reported to a network side device, where the capability indication information is configured to indicate that the terminal device supports simultaneous configuration of N measurement Gaps, and N is a positive integer.

In the example of the disclosure, the terminal device may report the capability indication information of the terminal device to the network side device, so as to inform the network side device that the terminal device supports simultaneous configuration of the N measurement Gaps.

It may be understood that the terminal device supports simultaneous configuration of the N measurement Gaps, and the terminal device also supports simultaneous configuration of less than N measurement Gaps.

For example, in a case that N is 3, the terminal device reports the capability indication information of the terminal device to the network side device, so as to inform the network side device that the terminal device supports simultaneous configuration of the 3 measurement Gaps, which may be understood that the terminal device supports configuration of 1 measurement Gap, and also supports simultaneous configuration of 2 measurement Gaps.

It needs to be noted that the above examples are schematic, and are not intended to specifically limit the example of the disclosure. In the example of the disclosure, N may also be any value other than 3.

In the example of the disclosure, the terminal device reports the capability indication information of the terminal device to the network side device via an RRC signaling.

S22: configuration information sent by the network side device is received, where the configuration information is configured by the network side device according to the capability indication information, and the configuration information includes M measurement Gap configurations, where M is a positive integer less than or equal to N.

In the example of the disclosure, after receiving the capability indication information reported by the terminal device, the network side device sends the configuration information to the terminal device according to the number N of the measurement Gaps supported for simultaneous configuration by the terminal device and indicated by the capability indication information, and configures M (less than or equal to N) measurement Gap configurations for the terminal device.

For example, in the case that N is 3, after receiving the capability indication information reported by the terminal device, the network side device configures, according to the number of the measurement Gaps supported for simultaneous configuration by the terminal device and indicated by the capability indication information being 3, 3 measurement Gap configurations for the terminal device, or configures 2 measurement Gap configurations for the terminal device, or configures 1 measurement Gap configuration for the terminal device.

It needs to be noted that the above examples are schematic, and are not intended to specifically limit the example of the disclosure. In the example of the disclosure, N may also be any value other than 3.

S23: first indication information sent by the network side device is received, where the first indication information is configured to indicate that the terminal device performs mobility measurement.

In the example of the disclosure, the network side device may instruct the terminal device to perform the mobility measurement via an RRC signaling.

S24: the mobility measurement is performed according to the first indication information and the configuration information.

It may be understood that based on the above terminal device reports the capability indication information of the terminal device to the network side device, where the capability indication information is configured to indicate that the terminal device supports the simultaneous configuration of N measurement Gaps, the network side device sends the configuration information to the terminal device according to the capability indication information, and configures the M measurement Gap configurations for the terminal device, and when the terminal device receives the first indication information from the network side device to indicate to perform the mobility measurement, the terminal device is able to perform the mobility measurement according to the first indication information and the configuration information.

In the example of the disclosure, the terminal device is supported to report the capability indication information supporting measurement, and the network side device is able to configure suitable measurement resources for the terminal device according to the capability indication information reported by the terminal device, so that the terminal device is able to use the suitable measurement resources to perform the mobility measurement, thus reducing energy consumption of the terminal device.

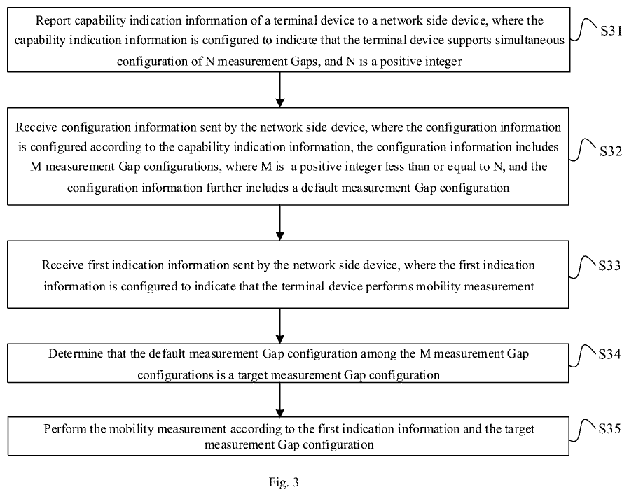

Please refer to FIG. 3, and FIG. 3 is a flow diagram of another measurement method provided by an example of the disclosure.

As shown in FIG. 3, the measurement method is executed by a terminal device, and may include, but is not limited to the following steps:

S31: capability indication information of the terminal device is reported to a network side device, where the capability indication information is configured to indicate that the terminal device supports simultaneous configuration of N measurement Gaps, and N is a positive integer.

In the example of the disclosure, for the relevant description of S31 above, please refer to the relevant description of S21 in the above example, which will not be repeated here.

S32: configuration information sent by the network side device is received, where the configuration information is configured according to the capability indication information, the configuration information includes M measurement Gap configurations, where M is a positive integer less than or equal to N, and the configuration information further includes a default measurement Gap configuration.

In the example of the disclosure, for the relevant description of S32 above, please refer to the relevant description of S22 in the above example.

In the example of the disclosure, the network side device sends the configuration information to the terminal device according to the capability indication information reported by the terminal device, and configures M measurement Gap configurations for the terminal device, including one default measurement Gap configuration.

S33: first indication information sent by the network side device is received, where the first indication information is configured to indicate that the terminal device performs mobility measurement.

In the example of the disclosure, the network side device may instruct the terminal device to perform the mobility measurement via an RRC signaling.

S34: it is determined that the default measurement Gap configuration is a target measurement Gap configuration.

S35: the mobility measurement is performed according to the first indication information and the target measurement Gap configuration.

In the example of the disclosure, in a case that the network side device sends the configuration information to the terminal device according to the capability indication information reported by the terminal device, and configures the M measurement Gap configurations for the terminal device, including one default measurement Gap configuration, the terminal device receives M measurement Gap configurations, determines the default measurement Gap configuration as the target measurement Gap configuration, and then performs the mobility measurement according to first indication information and the target measurement Gap configuration.

In the example of the disclosure, the terminal device is supported to report the capability indication information supporting measurement, and the network side device is able to configure suitable measurement resources for the terminal device according to the capability indication information reported by the terminal device, so that the terminal device is able to use the suitable measurement resources to perform the mobility measurement, thus reducing energy consumption of the terminal device.

Please refer to FIG. 4, and FIG. 4 is a flow diagram of yet another measurement method provided by an example of the disclosure.

As shown in FIG. 4, the measurement method is executed by a terminal device, and may include, but is not limited to the following steps:

S41: capability indication information of the terminal device is reported to a network side device, where the capability indication information is configured to indicate that the terminal device supports simultaneous configuration of N measurement Gaps, and N is a positive integer.

S42: configuration information sent by the network side device is received, where the configuration information is configured according to the capability indication information, and the configuration information includes M measurement Gap configurations, where M is a positive integer less than or equal to N.

S43: first indication information sent by the network side device is received, where the first indication information is configured to indicate that the terminal device performs mobility measurement.

In the example of the disclosure, for the relevant description of S41, S42 and S43 above, please refer to the relevant description of S21, S22 and S23 in the above example, which will not be repeated here.

S44: it is determined that the M measurement Gap configurations are all target measurement Gap configurations.

In the example of the disclosure, in a case that the network side device configures M measurement Gap configurations for the terminal device according to the capability indication information reported by the terminal device, the terminal device receives M measurement Gap configurations, and determines that the M measurement Gap configurations are all target measurement Gap configurations.

S45: a first corresponding relationship, configured by the network side device, between the measurement Gap configurations and an SSB based RRM measurement timing configuration (SMTC) in a measurement object (MO) is received.

S46: a target SMTC in a target measurement object (MO) is determined according to the target measurement Gap configurations and the first corresponding relationship.

S47: the mobility measurement is performed according to the target measurement Gap configuration and the target SMTC.

In the examples of the disclosure, the network side device configures, for the terminal device, the first corresponding relationship between the measurement Gap configurations and the SMTC in the measurement object (MO), so that in the case where the terminal device determines that the M measurement GAP are all the target measurement Gap configurations, the terminal device may determine the target SMTC in the target measurement object (MO) corresponding to the target measurement Gap configurations according to the target measurement Gap configurations and the first corresponding relationship.

Based on this, after determining the target measurement Gap configurations and the target SMTC, the mobility measurement is performed according to the target measurement Gap configuration and the target SMTC.

In the example of the disclosure, the terminal device is supported to report the capability indication information supporting measurement, so that the network side device is able to configure suitable measurement resources (target measurement Gap configurations) for the terminal device according to the capability indication information reported by the terminal device. Further, the network side device may further configure the first corresponding relationship between the measurement Gap configurations and the SMTC in the measurement object (MO), then, after the target measurement Gap configurations and the target SMTC are determined according to the target measurement Gap configurations and the first corresponding relationship, the mobility measurement is performed according to the target measurement Gap configurations and the target SMTC, so that the terminal device is able to use the suitable measurement resources to perform the mobility measurement on corresponding frequency points, reducing energy consumption of the terminal device.

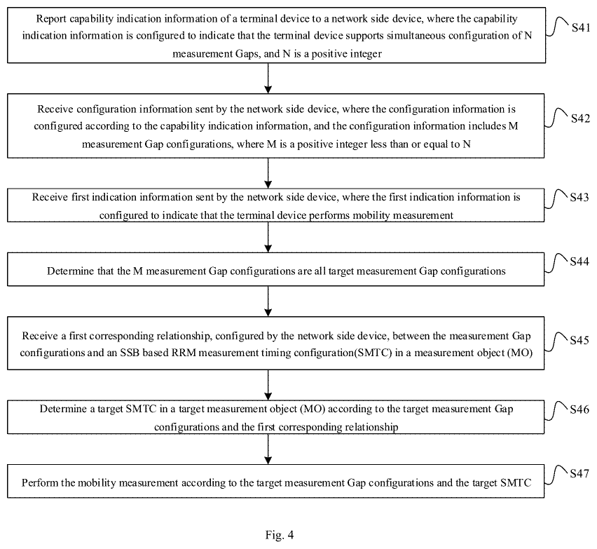

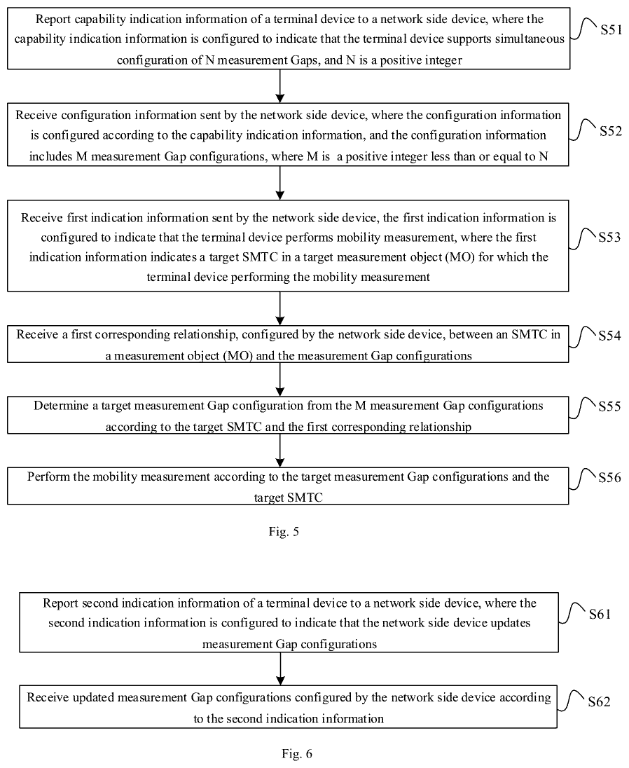

Please refer to FIG. 5, and FIG. 5 is a flow diagram of yet another measurement method provided by an example of the disclosure.

As shown in FIG. 5, the measurement method is executed by a terminal device, and may include, but is not limited to the following steps:

S51: capability indication information of the terminal device is reported to a network side device, where the capability indication information is configured to indicate that the terminal device supports simultaneous configuration of N measurement Gaps, and N is a positive integer.

S52: configuration information sent by the network side device is received, where the configuration information is configured according to the capability indication information, and the configuration information includes M measurement Gap configurations, where M is a positive integer less than or equal to N.

In the example of the disclosure, for the relevant description of S51 and S52 above, please refer to the relevant description of S21 and S22 in the above example, which will not be repeated here.

S53: first indication information sent by the network side device is received, the first indication information is configured to indicate that the terminal device performs mobility measurement, where the first indication information indicates a target SMTC in a target measurement object (MO) for which the terminal device performing the mobility measurement.

In the example of the disclosure, the network side device may instruct the terminal device to perform the mobility measurement via an RRC signaling.

The first indication information indicates the target SMTC in the target measurement object (MO) for which the terminal device performing the mobility measurement, so that the terminal device is able to determine the target SMTC.

S54: a first corresponding relationship, configured by the network side device, between an SMTC in a measurement object (MO) and the measurement Gap configurations is received.

S55: a target measurement Gap configuration is determined from the M measurement Gap configurations according to the target SMTC and the first corresponding relationship.

S56: the mobility measurement is performed according to the target measurement Gap configuration and the target SMTC.

In the example of the disclosure, the network side device configures, for the terminal device, the first corresponding relationship between the SMTC in the measurement object (MO) and the measurement Gap configurations, so that in the case where the terminal device determines the target SMTC, the terminal device may determine the target measurement Gap configurations corresponding to the target SMTC according to the target SMTC and the first corresponding relationship.

Based on this, after determining the target SMTC and the target measurement Gap configurations, the mobility measurement is performed according to the target SMTC and the target measurement Gap configurations.

In the example of the disclosure, the terminal device is supported to report the capability indication information supporting measurement, so that the network side device is able to configure suitable measurement resources (M measurement Gap configurations) for the terminal device according to the capability indication information reported by the terminal device. Furthermore, in the first indication information that the network side device instructs the terminal device to perform the mobility measurement, the target SMTC in the target measurement object (MO) for which the terminal device performing the mobility measurement is indicated, and the terminal device is able to determine the target SMTC according to the first indication information. The network side device further configures the first corresponding relationship between the SMTC and the measurement Gap configurations for the terminal device, and the terminal device is able to determine the target measurement Gap configurations according to the target SMTC and the first corresponding relationship. After determining the target SMTC and the target measurement Gap configurations, the mobility measurement is performed according to the target SMTC and the target measurement Gap configuration, so that the terminal device is able to use the suitable measurement resources to perform the mobility measurement on corresponding frequency points, reducing energy consumption of the terminal device.

Please refer to FIG. 6, and FIG. 6 is a flow diagram of yet another measurement method provided by an example of the disclosure.

As shown in FIG. 6, the measurement method is executed by a terminal device, and may include, but is not limited to the following steps:

S61: second indication information of the terminal device is reported to a network side device, where the second indication information is configured to indicate that the network side device updates measurement Gap configurations.

In the example of the disclosure, the terminal device may report the demand for updating the measurement Gap configurations to the network side device via an RRC signaling.

It may be understood that the terminal device may report the second indication information to inform the network side device that the configured measurement Gap configurations need to be updated.

A timing for the terminal device to report the second indication information may be set as needed, which is not specifically limited by the examples of the disclosure.

S62: updated measurement Gap configurations configured by the network side device according to the second indication information are received.

In the example of the disclosure, after receiving the second indication information of the terminal device, the network side device updates the configured measurement Gap configurations according to the second indication information to obtain the updated measurement Gap configurations, and sends the updated measurement Gap configurations to the terminal device.

It needs to be noted that S61 and S62 may be implemented separately, or may also be implemented together in combination with any other step in the examples of the disclosure, for example, implemented together in combination with S21 to S24 and/or S31 to S35 and/or S41 to S47 and/or S51 to S56 in the examples of the disclosure, which is not limited by the examples of the disclosure.

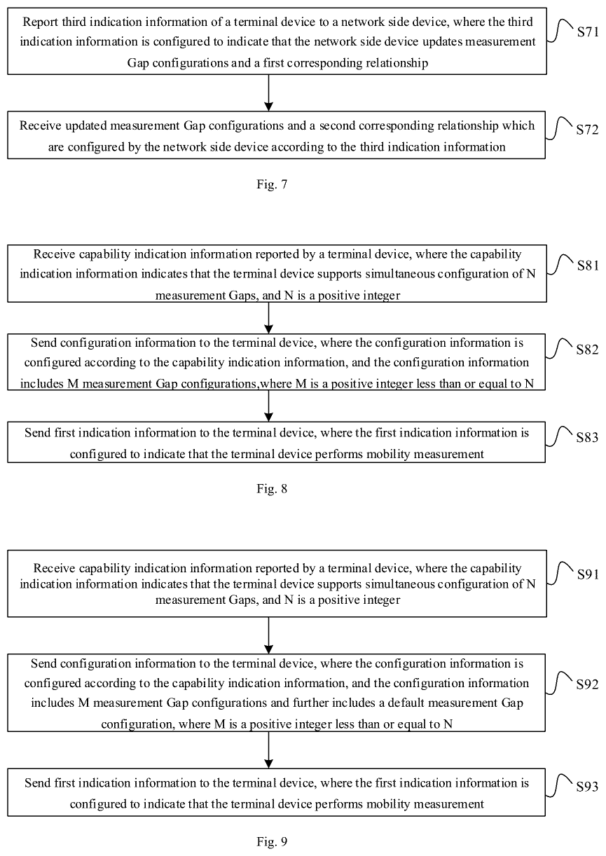

Please refer to FIG. 7, and FIG. 7 is a flow diagram of yet another measurement method provided by an example of the disclosure.

As shown in FIG. 7, the measurement method is executed by a terminal device, and may include, but is not limited to the following steps:

S71: third indication information of the terminal device is reported to a network side device, where the third indication information is configured to indicate that the network side device updates measurement Gap configurations and a first corresponding relationship.

In the example of the disclosure, the terminal device may report the demand for updating the measurement Gap configurations and the first corresponding relationship to the network side device via an RRC signaling.

It may be understood that the terminal device may report the third indication information to inform the network side device that the configured measurement Gap configurations and the first corresponding relationship need to be updated.

A timing for the terminal device to report the third indication information may be set as needed, which is not specifically limited by the examples of the disclosure.

S72: updated measurement Gap configurations and a second corresponding relationship which are configured by the network side device according to the third indication information are received.

In the example of the disclosure, after receiving the third indication information of the terminal device, the network side device updates the configured measurement Gap configurations according to the third indication information to obtain the updated measurement Gap configurations, updates the first corresponding relationship to obtain the second corresponding relationship, and sends the updated measurement Gap configurations and the second corresponding relationship to the terminal device.

It needs to be noted that S71 and S72 may be implemented separately, or may also be implemented together in combination with any other step in the examples of the disclosure, for example, implemented together in combination with S21 to S24 and/or S31 to S35 and/or $41 to S47 and/or S51 to S56 in the examples of the disclosure, which is not limited by the examples of the disclosure.

Please refer to FIG. 8, and FIG. 8 is a flow diagram of yet another measurement method provided by an example of the disclosure.

As shown in FIG. 8, the measurement method is executed by a network side device, and may include, but is not limited to the following steps:

S81: capability indication information reported by a terminal device is received, where the capability indication information indicates that the terminal device supports simultaneous configuration of N measurement Gaps, and N is a positive integer.

In the example of the disclosure, the terminal device may report the capability indication information of the terminal device to the network side device, so as to inform the network side device that the terminal device supports simultaneous configuration of the N measurement Gaps.

It may be understood that the terminal device supports simultaneous configuration of the N measurement Gaps, and the terminal device also supports simultaneous configuration of less than N measurement Gaps.

For example, in a case that Nis 3, the terminal device reports the capability indication information of the terminal device to the network side device, so as to inform the network side device that the terminal device supports simultaneous configuration of the 3 measurement Gaps, which may be understood that the terminal device supports configuration of 1 measurement Gap, and also supports simultaneous configuration of 2 measurement Gaps.

It needs to be noted that the above examples are schematic, and are not intended to specifically limit the example of the disclosure. In the example of the disclosure, N may also be any value other than 3.

In the example of the disclosure, the terminal device reports the capability indication information of the terminal device to the network side device via an RRC signaling.

S82: configuration information is sent to the terminal device, where the configuration information is configured according to the capability indication information, and the configuration information includes M measurement Gap configurations, where M is a positive integer less than or equal to N.

In the example of the disclosure, after receiving the capability indication information reported by the terminal device, the network side device configures M (less than or equal to N) measurement Gap configurations for the terminal device according to the number N of the measurement Gaps supported for simultaneous configuration by the terminal device and indicated by the capability indication information.

For example, in the case that N is 3, after receiving the capability indication information reported by the terminal device, the network side device configures, according to the number of the measurement Gaps supported for simultaneous configuration by the terminal device and indicated by the capability indication information being 3, 3 measurement Gap configurations for the terminal device, or configures 2 measurement Gap configurations for the terminal device, or configures 1 measurement Gap configuration for the terminal device.

It needs to be noted that the above examples are schematic, and are not intended to specifically limit the example of the disclosure. In the example of the disclosure, N may also be any value other than 3.

S83: first indication information is sent to the terminal device, where the first indication information is configured to indicate that the terminal device performs mobility measurement.

In the example of the disclosure, the network side device may instruct the terminal device to perform the mobility measurement via an RRC signaling.

It may be understood that the capability indication information of the terminal device is reported to the network side device based on the terminal device, where the capability indication information is configured to indicate that the terminal device supports the simultaneous configuration of N measurement Gaps, the network side device sends the configuration information to the terminal device according to the capability indication information, and configures the M measurement Gap configurations for the terminal device, and when the terminal device receives the first indication information from the network side device to indicate to perform the mobility measurement, the terminal device is able to perform the mobility measurement according to the first indication information and the M measurement Gap configurations configured by the configuration information.

In the example of the disclosure, the terminal device is supported to report the capability indication information supporting measurement, and the network side device is able to configure suitable measurement resources for the terminal device according to the capability indication information reported by the terminal device, so that the terminal device is able to use the suitable measurement resources to perform the mobility measurement, thus reducing energy consumption of the terminal device.

Please refer to FIG. 9, and FIG. 9 is a flow diagram of yet another measurement method provided by an example of the disclosure.

As shown in FIG. 9, the measurement method is executed by a network side device, and may include, but is not limited to the following steps:

S91: capability indication information reported by a terminal device is received, where the capability indication information indicates that the terminal device supports simultaneous configuration of N measurement Gaps, and N is a positive integer.

In the example of the disclosure, for the relevant description of S91 above, please refer to the relevant description of S81 in the above example, which will not be repeated here.

S92: configuration information is sent to the terminal device, where the configuration information is configured according to the capability indication information, and the configuration information includes M measurement Gap configurations and further includes a default measurement Gap configuration, where M is a positive integer less than or equal to N.

In the example of the disclosure, for the relevant description of S92 above, please refer to the relevant description of S82 in the above example.

In the example of the disclosure, the M measurement Gap configurations configured by the network side device for the terminal device according to the capability indication information reported by the terminal device include one default measurement Gap configuration.

S93: first indication information is sent to the terminal device, where the first indication information is configured to indicate that the terminal device performs mobility measurement.

In the example of the disclosure, for the relevant description of S93 above, please refer to the relevant description of S83 in the above example, which will not be repeated here.

In the example of the disclosure, in a case that the network side device sends the configuration information to the terminal device according to the capability indication information reported by the terminal device, and configures the M measurement Gap configurations for the terminal device, and the configuration information further includes one default measurement Gap configuration, the terminal device receives the configuration information, determines the default measurement Gap configuration as a target measurement Gap configuration, and then performs the mobility measurement according to first indication information and the target measurement Gap configuration.

In the example of the disclosure, the terminal device is supported to report the capability indication information supporting measurement, and the network side device is able to configure suitable measurement resources for the terminal device according to the capability indication information reported by the terminal device, so that the terminal device is able to use the suitable measurement resources to perform the mobility measurement, thus reducing energy consumption of the terminal device.

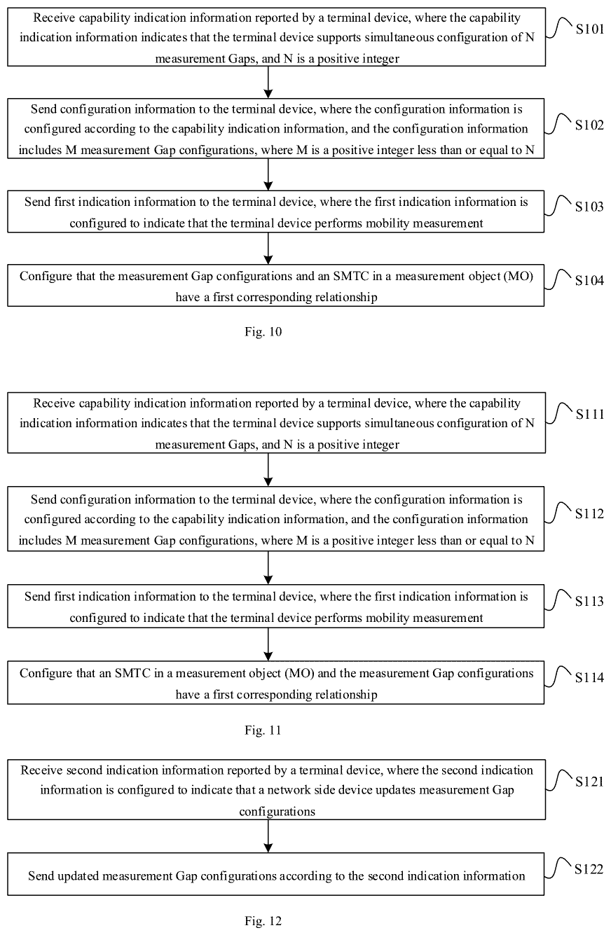

Please refer to FIG. 10, and FIG. 10 is a flow diagram of yet another measurement method provided by an example of the disclosure.

As shown in FIG. 10, the measurement method is executed by a network side device, and may include, but is not limited to the following steps:

S101: capability indication information reported by a terminal device is received, where the capability indication information indicates that the terminal device supports simultaneous configuration of N measurement Gaps, and N is a positive integer.

S102: configuration information is sent to the terminal device, where the configuration information is configured according to the capability indication information, and the configuration information includes M measurement Gap configurations, where M is a positive integer less than or equal to N.

S103: first indication information is sent to the terminal device, where the first indication information is configured to indicate that the terminal device performs mobility measurement.

In the example of the disclosure, for the relevant description of S101 to S103 above, please refer to the relevant description of S81 to S83 in the above example, which will not be repeated here.

S104: a first corresponding relationship between the measurement Gap configurations and an SMTC in a measurement object (MO) is configured.

In the example of the disclosure, in a case that the network side device sends the configuration information to the terminal device and configures M measurement Gap configurations for the terminal device according to the capability indication information reported by the terminal device, the terminal device receives the M measurement Gap configurations, and determines that the M measurement Gap configurations are all target measurement Gap configurations.

In the examples of the disclosure, the network side device configures, for the terminal device, the first corresponding relationship between the measurement Gap configurations and the SMTC in the measurement object (MO), so that in the case where the terminal device determines that the M measurement GAP configurations are all the target measurement Gap configurations, the terminal device may determine the target SMTC in the target measurement object (MO) corresponding to the target measurement Gap configurations according to the target measurement Gap configurations and the first corresponding relationship.

Based on this, after determining the target measurement Gap configurations and the target SMTC, the mobility measurement is performed according to the target measurement Gap configuration and the target SMTC.

In the example of the disclosure, the terminal device is supported to report the capability indication information supporting measurement, so that the network side device is able to configure suitable measurement resources (target measurement Gap configurations) for the terminal device according to the capability indication information reported by the terminal device. Further, the network side device may further configure the first corresponding relationship between the measurement Gap configurations and the SMTC in the measurement object (MO), then, after the target measurement Gap configurations and the target SMTC are determined according to the target measurement Gap configurations and the first corresponding relationship, the mobility measurement is performed according to the target measurement Gap configurations and the target SMTC, so that the terminal device is able to use the suitable measurement resources to perform the mobility measurement on corresponding frequency points, reducing energy consumption of the terminal device.

Please refer to FIG. 11, and FIG. 11 is a flow diagram of yet another measurement method provided by an example of the disclosure.

As shown in FIG. 11, the measurement method is executed by a network side device, and may include, but is not limited to the following steps:

S111: capability indication information reported by a terminal device is received, where the capability indication information indicates that the terminal device supports simultaneous configuration of N measurement Gaps, and N is a positive integer.

S112: configuration information is sent to the terminal device, where the configuration information is configured according to the capability indication information, and the configuration information includes M measurement Gap configurations, where M is a positive integer less than or equal to N.

S113: first indication information is sent to the terminal device, where the first indication information is configured to indicate that the terminal device performs mobility measurement, and the first indication information indicates a target SMTC in a target measurement object (MO) for which the terminal device performing the mobility measurement.

In the example of the disclosure, for the relevant description of S111 to S113 above, please refer to the relevant description of S81 to S83 in the above example, which will not be repeated here.

The first indication information indicates the target SMTC in the target measurement object (MO) for which the terminal device performing the mobility measurement, so that the terminal device is able to determine the target SMTC.

S114: a first corresponding relationship between an SMTC in a measurement object (MO) and the measurement Gap configurations is configured.

In the example of the disclosure, the network side device configures, for the terminal device, the first corresponding relationship between the SMTC in the measurement object (MO) and the measurement Gap configurations, so that in the case where the terminal device determines the target SMTC, the terminal device may determine the target measurement Gap configurations corresponding to the target SMTC according to the target SMTC and the first corresponding relationship.

Based on this, after determining the target SMTC and the target measurement Gap configurations, the mobility measurement is performed according to the target SMTC and the target measurement Gap configurations.

In the example of the disclosure, the terminal device is supported to report the capability indication information supporting measurement, so that the network side device is able to send the configuration information to the terminal device and configure suitable measurement resources (M measurement Gap configurations) for the terminal device according to the capability indication information reported by the terminal device. Furthermore, in the first indication information that the network side device instructs the terminal device to perform the mobility measurement, the target SMTC in the target measurement object (MO) for which the terminal device performing the mobility measurement is indicated, and the terminal device is able to determine the target SMTC according to the first indication information. The network side device further configures the first corresponding relationship between the SMTC and the measurement Gap configurations for the terminal device, and the terminal device is able to determine the target measurement Gap configurations according to the target SMTC and the first corresponding relationship. After determining the target SMTC and the target measurement Gap configurations, the mobility measurement is performed according to the target SMTC and the target measurement Gap configuration, so that the terminal device is able to use the suitable measurement resources to perform the mobility measurement on corresponding frequency points, reducing energy consumption of the terminal device.

Please refer to FIG. 12, and FIG. 12 is a flow diagram of yet another measurement method provided by an example of the disclosure.

As shown in FIG. 12, the measurement method is executed by a network side device, and may include, but is not limited to the following steps:

S121: second indication information reported by the terminal device is received, where the second indication information is configured to indicate that the network side device updates the measurement Gap configurations.

S122: updated measurement Gap configurations are sent according to the second indication information.

In the example of the disclosure, for the relevant description of S121 and S122 above, please refer to the relevant description of S61 and S62 in the above example, which will not be repeated here.

It needs to be noted that S121 and S122 may be implemented separately, or may also be implemented together in combination with any other step in the examples of the disclosure, for example, implemented together in combination with S81 to S83 and/or S91 to S93 and/or S101 to S104 and/or S111 to S114 in the examples of the disclosure, which is not limited by the examples of the disclosure.

Please refer to FIG. 13, and FIG. 13 is a flow diagram of yet another measurement method provided by an example of the disclosure.

As shown in FIG. 13, the measurement method is executed by a network side device, and may include, but is not limited to the following steps:

S131: third indication information reported by a terminal device is received, where the third indication information is configured to indicate that the network side device updates measurement Gap configurations and a first corresponding relationship.

S132: updated measurement Gap configurations and a second corresponding relationship are sent according to the third indication information.

In the example of the disclosure, for the relevant description of S131 and S132 above, please refer to the relevant description of S71 and S72 in the above example, which will not be repeated here.

It needs to be noted that S131 and S132 may be implemented separately, or may also be implemented together in combination with any other step in the examples of the disclosure, for example, implemented together in combination with S81 to S83 and/or S91 to S93 and/or S101 to S104 and/or S111 to S114 in the examples of the disclosure, which is not limited by the examples of the disclosure.

In the above examples provided by the disclosure, the measurement methods provided by the examples of the disclosure are respectively introduced from the perspectives of the network side device and the terminal device. In order to implement the various functions in the measurement methods provided by the examples of the disclosure, the network side device and the terminal device may include a hardware structure and a software module, and the above various functions are implemented in the form of the hardware structure, the software module, or the hardware structure and the software module. One of the above various functions may be executed in the form of the hardware structure, the software module, or the hardware structure and the software module.

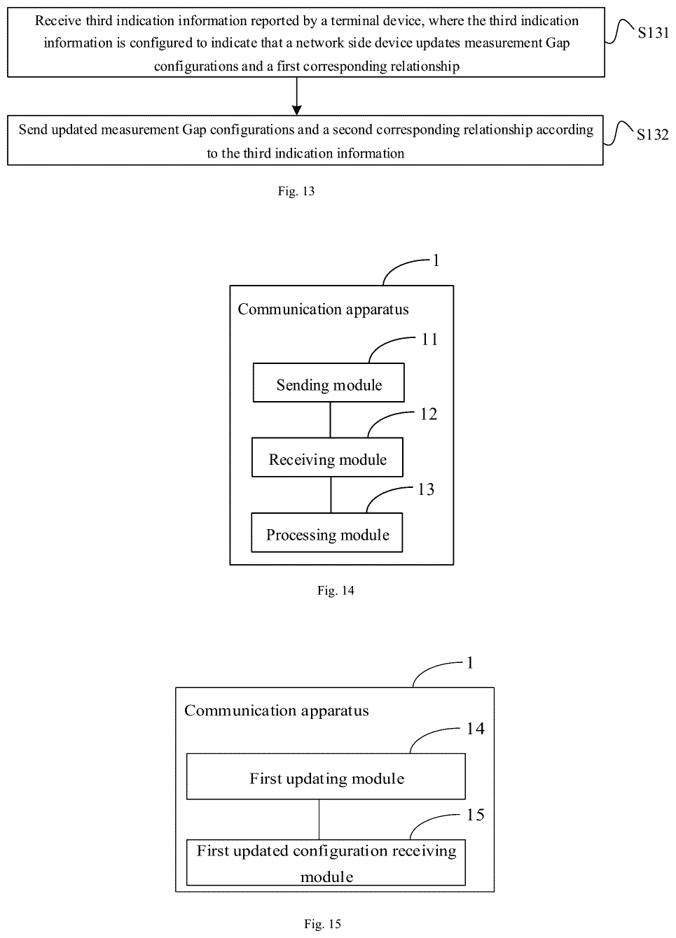

Please refer to FIG. 14, and FIG. 14 is a structural diagram of a communication apparatus 1 provided by an example of the disclosure.

The communication apparatus 1 may be a terminal device, or an apparatus in the terminal device, or an apparatus that can be matched with the terminal device for use.

The communication apparatus 1 is the terminal device:
the communication apparatus 1 includes: a sending module 11, a receiving module 12 and a processing module 13.

The sending module 11 is configured to send capability indication information of the terminal device to a network side device, where the capability indication information is configured to indicate that the terminal device supports simultaneous configuration of N measurement Gaps, and N is a positive integer.

The receiving module 12 is configured to receive configuration information sent by the network side device, where the configuration information is configured by the network side device according to the capability indication information, and the configuration information includes M measurement Gap configurations, where M is a positive integer less than or equal to N.

The receiving module 12 is further configured to receive first indication information sent by the network side device, where the first indication information is configured to indicate that the terminal device performs mobility measurement.

The processing module 13 is configured to perform the mobility measurement according to the first indication information and the configuration information.

In some examples, the M measurement Gap configurations include a default measurement Gap configuration, and the processing module 13 is specifically configured to determine that the default measurement Gap configuration is a target measurement Gap configuration; and perform the mobility measurement according to the first indication information and the target measurement Gap configuration.

In some other examples, the processing module 13 is specifically configured to determine that the M measurement Gap configurations are all target measurement Gap configurations; receive a first corresponding relationship, configured by the network side device, between the measurement Gap configurations and an SSB based RRM measurement timing configuration (SMTC) in a measurement object (MO); determine a target SMTC in a target measurement object (MO) according to the target measurement Gap configurations and the first corresponding relationship; and perform the mobility measurement according to the target measurement Gap configurations and the target SMTC.

In some another examples, the first indication information indicates a target SMTC in a target measurement object (MO) for which the terminal device performing the mobility measurement, and the processing module 13 is specifically configured to receive a first corresponding relationship, configured by the network side device, between an SMTC in a measurement object (MO) and the measurement Gap configurations; determine a target measurement Gap configuration from the M measurement Gap configurations according to the target SMTC and the first corresponding relationship; and perform the mobility measurement according to the target measurement Gap configuration and the target SMTC.

As shown in FIG. 15, in some examples, the communication apparatus 1 further includes: a first updating module 14 and a first updated configuration receiving module 15.

The first updating module 14 is configured to report second indication information of the terminal device to the network side device, where the second indication information is configured to indicate that the network side device updates the measurement Gap configurations.

The first updated configuration receiving module 15 is configured to receive updated measurement Gap configurations configured by the network side device according to the second indication information.

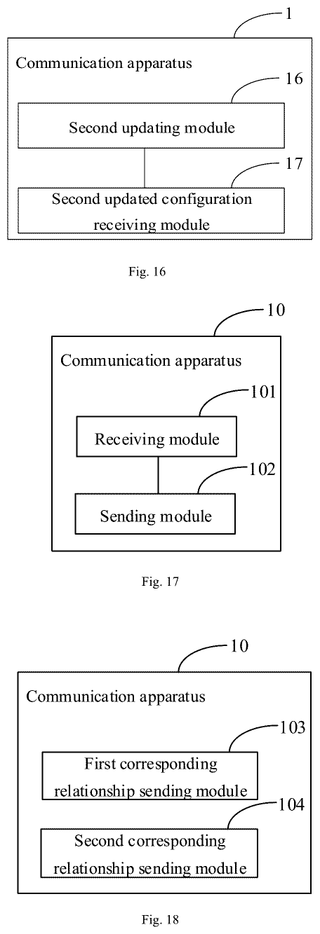

As shown in FIG. 16, in some other examples, the communication apparatus 1 further includes: a second updating module 16 and a second updated configuration receiving module 17.

The second updating module 16 is configured to report third indication information of the terminal device to the network side device, where the third indication information is configured to indicate that the network side device updates the measurement Gap configurations and the first corresponding relationship.

The second updated configuration receiving module 17 is configured to receive updated measurement Gap configurations and a second corresponding relationship configured by the network side device according to the third indication information.

As shown in FIG. 17, in the example of the disclosure, the communication apparatus 10 may be a network side device, or an apparatus in the network side device, or an apparatus that can be matched with the network side device for use.

The communication apparatus 10 is the network side device:
the communication apparatus 10 includes: a receiving module 101 and a sending module 102.

The receiving module 101 is configured to receive capability indication information reported by a terminal device, where the capability indication information indicates that the terminal device supports simultaneous configuration of N measurement Gaps, and N is a positive integer.

The sending module 102 is configured to send configuration information to the terminal device, where the configuration information is configured by the network side device according to the capability indication information, and the configuration information includes M measurement Gap configurations, where M is a positive integer less than or equal to N.

The sending module 102 is further configured to send first indication information to the terminal device, where the first indication information is configured to indicate that the terminal device performs mobility measurement.

In some examples, the configuration information further includes a default measurement Gap configuration.

As shown in FIG. 18, in some examples, the communication apparatus 10 further includes: a first corresponding relationship sending module 103.

The first corresponding relationship sending module 103 is configured to configure a first corresponding relationship between the measurement Gap configurations and an SMTC in a measurement object (MO).

Continuing to refer to FIG. 18, in some examples, the communication apparatus 10 further includes: a second corresponding relationship sending module 104.

The second corresponding relationship sending module 104 is configured to configure a first corresponding relationship between the SMTC in the measurement object (MO) and the measurement Gap configurations.

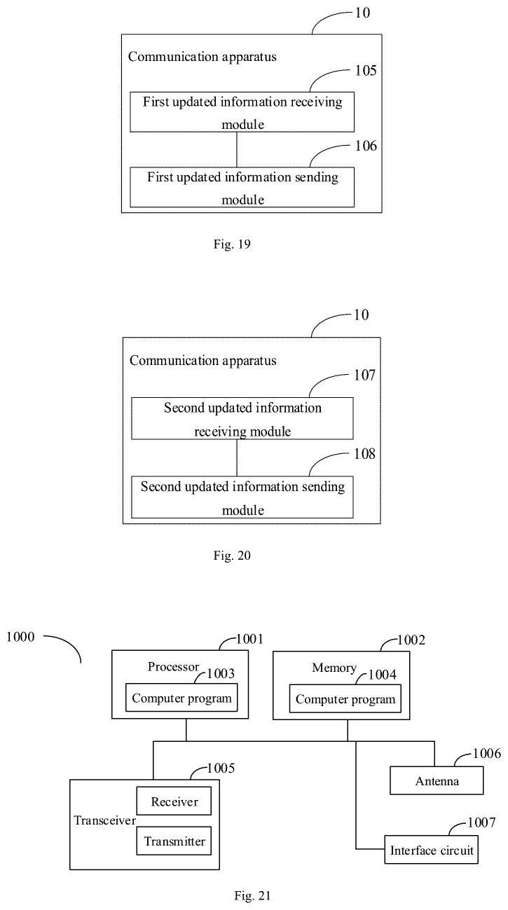

As shown in FIG. 19, in some examples, the communication apparatus 10 further includes: a first updated information receiving module 105 and a first updated information sending module 106.

The first updated information receiving module 105 is configured to receive second indication information reported by the terminal device, where the second indication information is configured to indicate that the network side device updates the measurement Gap configurations.

The first updated information sending module 106 is configured to send updated measurement Gap configurations according to the second indication information.

As shown in FIG. 20, in some examples, the communication apparatus 10 further includes: a second updated information receiving module 107 and a second updated information sending module 108.

The second updated information receiving module 107 is configured to receive third indication information reported by the terminal device, where the third indication information is configured to indicate that the network side device updates the measurement Gap configurations and the first corresponding relationship.

The second updated information sending module 108 is configured to send updated measurement Gap configurations and a second corresponding relationship according to the third indication information.

As for the communication apparatus in the above examples, the specific modes for executing operations by all the modules have been described in the examples related to the measurement method in detail, which is not illustrated in detail here.

The communication apparatus provided in the above examples of the disclosure has the same or similar beneficial effects as a measurement method provided in some examples above, which is not repeated here.

Please refer to FIG. 21, and FIG. 21 is a schematic structural diagram of another communication apparatus 1000 provided by an example of the disclosure. The communication apparatus 1000 may be a network side device, may also be a terminal device, may also be a chip, a system on a chip, or a processor that supports the network side device to implement the measurement methods above, and may further be a chip, a system on a chip, or a processor that supports the terminal device to implement the measurement methods above. The communication apparatus 1000 may be configured to implement the measurement methods described in the above method examples, which may specifically refer to illustration in the above method examples.

The communication apparatus 1000 may include one or more processors 1001. The processor 1001 may be a general-purpose processor or a dedicated processor. For example, it may be a baseband processor or a central processing unit. The baseband processor may be configured to process a communication protocol and communication data, while the central processing unit may be configured to control the communication apparatus (such as a base station, a baseband chip, a terminal device, a terminal device chip, and a DU or a CU), execute a computer program, and process data from the computer program.

In some examples, the communication apparatus 1000 may further include one or more memories 1002 on which a computer program 1004 may be stored, and the processor 1002 executes the computer program 1004 to cause the communication apparatus 1000 to execute the measurement methods described in the above method examples. In some examples, the memory 1002 may further store data. The communication apparatus 1000 and the memory 1002 may be arranged separately or integrated together.

In some examples, the communication apparatus 1000 may further include a transceiver 1005 and an antenna 1006. The transceiver 1005 may be referred to as a transceiving unit, a transceiving machine, or a transceiving circuit, etc., configured to achieve a transceiving function. The transceiver 1005 may include a receiver and a transmitter, and the receiver may be referred to as a receiving machine or a receiving circuit, for achieving a reception function; and the transmitter may be referred to as a transmitting machine or a transmitting circuit, for achieving a transmitting function.

In some examples, the communication apparatus 1000 may further include one or more interface circuits 1007. The interface circuit 1007 is configured to receive code instructions and transmitting the same to the processor 1001. The processor 1001 runs the code instructions to cause the communication apparatus 1000 to execute the measurement method described in the above method examples.

In an implementation, the processor 1001 may include a transceiver for implementing receiving and transmitting functions. For example, the transceiver may be a transceiving circuit, an interface, or an interface circuit. The transceiving circuit, interface, or interface circuit configured to achieve the receiving and transmitting functions may be separate or integrated together. The above transceiving circuit, interface, or interface circuit can be configured to read and write codes/data, or the above transceiving circuit, interface, or interface circuit may be used for signal transmission or transferring.

In an implementation, the processor 1001 may store a computer program 1003, the computer program 1003 runs on the processor 1001, to cause the communication apparatus 1000 to execute the measurement methods described in the above method examples. The computer program 1003 may be cured in the processor 1001, in which case the processor 1001 may be implemented by hardware.

In an implementation, the communication apparatus 1000 may include a circuit, and the circuit may achieve the functions of transmitting, receiving, or communicating in the aforementioned method examples. The processor and transceiver described in the disclosure may be implemented on an integrated circuit (IC), an analog IC, a radio frequency integrated circuit (RFIC), a mixed signal IC, an application specific integrated circuit (ASIC), a printed circuit board (PCB), an electronic device, and the like. The processor and transceiver may also be manufactured by using various IC process technologies, such as a complementary metal oxide semiconductor (CMOS), an N Metal-oxide-semiconductor (NMOS), a positive channel metal oxide semiconductor (PMOS), a bipolar junction transistor (BJT), a bipolar CMOS (BiCMOS), silicon germanium (SiGe), and gallium arsenide (GaAs).

The communication apparatus described in the above examples may be the terminal device, but the scope of the communication apparatus described in the disclosure is not limited to this, and the structure of the communication apparatus may be not limited by FIG. 21. The communication apparatus may be an independent device or may be part of a larger device. For example, the communication apparatus may be:
(1) an independent integrated circuit (IC), or a chip, or a system on a chip or a subsystem;
(2) a set with one or more ICs, in some examples, the IC set also including a storage component for storing data and a computer program;
(3) an ASIC, such as a modem;
(4) a module that can be embedded in other devices;
(5) a receiving machine, a terminal device, an intelligent terminal device, a cellular phone, a wireless device, a handheld machine, a mobile unit, an on-board device, a network device, a cloud device, an artificial intelligence devices, etc.; and
(6) others and so on.

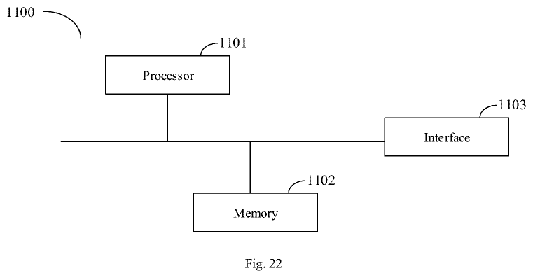

For a case that the communication apparatus may be a chip or a system on a chip, please refer to FIG. 22, and FIG. 22 is structural diagram of a chip provided in an example of the disclosure.

The chip 1100 includes a processor 1101 and an interface 1103. The number of the processor 1101 may be one or more, and the number of the interfaces 1103 may be multiple.

For a case in which the chip is used to implement a function of the terminal device in an example of the disclosure:
the interface 1103 is configured to receive code instructions and transmit the same to the processor.

The processor 1101 is configured to run the code instructions to perform the measurement method as described in some of the examples above.

For a case in which the chip is used to implement a function of the network side device in an example of the disclosure:
the interface 1103 is configured to receive code instructions and transmit the same to the processor.

The processor 1101 is configured to run the code instructions to perform the measurement method as described in some of the examples above.

In some examples, the chip 1100 further includes a memory 1102, and the memory 1102 is configured to store the needful computer program and data.

The skilled in the art can further understand that the various illustrative logical blocks and steps listed in the example of the disclosure may be implemented through electronic hardware, computer software, or a combination of the two. Whether such functions are implemented through hardware or software depends on the specific application and design requirements of the overall system. The skilled in the art can use various methods to achieve the described functions for each specific application, but such implementation needs not be understood as exceeding the scope of protection of the example of the disclosure.

An example of the disclosure further provides a measurement system. The system includes the communication apparatus as the terminal device and the communication apparatus as the network side device in the aforementioned example of FIG. 21.

The disclosure further provides a non-transitory computer readable storage medium on which instructions are stored, and the instructions, when executed by a computer, implement the functions of any of the above method examples.

The disclosure further provides a computer program product, and the computer program product, when executed by a computer, implements the functions of any of the above method examples.

In the above examples, it can be fully or partially implemented through software, hardware, firmware, or any combination of them. When implemented by using the software, it can be fully or partially implemented in a form of the computer program product. The computer program product includes one or more computer programs. When loading and executing the computer program on the computer, processes or functions described in the example of the disclosure are fully or partially generated. The computer may be a general-purpose computer, a dedicated computer, a computer network, or other programmable apparatuses. The computer program may be stored in a non-transitory computer readable storage medium or transmitted from one non-transitory computer readable storage medium to another. For example, the computer program may be transmitted from a website, a computer, a server or a data center to another website, computer, server, or data center through a wired (such as a coaxial cable, an optical fiber, a digital subscriber line (DSL)) or wireless (such as infrared, wireless, and microwave) mode. The non-transitory computer readable storage medium may be any available medium that the computer can access, or a data storage device such as a server or a data center that is integrated by one or more available media. The available medium may be a magnetic medium (such as a floppy disk, a hard drive, and a magnetic tape), an optical medium (such as a high-density digital video disc (DVD)), or a semiconductor medium (such as a solid state disk (SSD)), etc.

Those ordinarily skilled in the art can understand that the first, second, and other numerical numbers involved in the disclosure are differentiation for the convenience of description, and are not intended to limit the scope of the example of the disclosure, nor do they indicate the sequential order.

At least one in the disclosure can also be described as one or more, and a plurality of may be two, three, four, or more, which is not limited in the disclosure. In the example of the disclosure, for a technical feature, the technical features described in the technical feature are distinguished by “first”, “second”, “third”, “A”, “B”, “C”, and “D”, and the technical features described by “first”, “second”, “third”, “A”, “B”, “C”, and “D” have no any sequential order or order of size.

The corresponding relationships shown in tables in the disclosure can be configured or predefined. Values of information in each table are examples and can be configured as other values, which is not limited in the disclosure. When configuring the corresponding relationships between the information and various parameters, it does not need to configure all the corresponding relationships shown in each table. For example, in the tables in the disclosure, the corresponding relationships shown in certain rows may not be configured. For another example, appropriate deformation and adjustments, such as splitting and merging, can be made based on the above tables. The names of parameters shown in titles of the above tables may also use other names that can be understood by the communication apparatus, and the values or representations of the parameters may also be other values or representations understood by the communication apparatus. When implementing the above tables, other data structures can also be used, such as an array, a queue, a container, a stack, a linear table, a pointer, a linked list, a tree, a graph, a structure, a class, a heap, a hashing table, or a hash table.

The predefinition in the disclosure may be understood as being defined, pre-defined, stored, pre-stored, pre-negotiated, pre-configured, cured, or pre-fired.

Those ordinarily skilled in the art may realize that, units and algorithm steps of the examples described in the disclosed examples can be implemented by electronic hardware, or a combination of the computer software or the electronic hardware. Whether these functions are executed in a mode of the hardware or the software depends on particular applications and design constraint conditions of the technical solutions. Professional technicians may use different methods to implement the described functions for each particular application, but such implementation is not to be regarded beyond the scope of the disclosure.

Those skilled in the art may clearly understand that, for the convenience and simplicity of description, a specific working process of the above described system, apparatus and unit may refer to the corresponding process in the aforementioned method examples, and will not be repeated here.

The above is a specific example of the disclosure, but the scope of protection of the disclosure is not limited to this. Any changes or replacements that can be easily thought of by technical personnel familiar with the technical field within the technical scope disclosed in the disclosure needs to be covered within the scope of protection of the disclosure. Thus, the scope of protection of the disclosure needs to be subjected to the scope of protection of the claims.

1. A measurement method, executed by a terminal device, comprising:
reporting capability indication information of the terminal device to a network side device, wherein the capability indication information is configured to indicate that the terminal device supports simultaneous configuration of N measurement Gaps, and N is a positive integer;
receiving configuration information sent by the network side device, wherein the configuration information is configured by the network side device according to the capability indication information, and the configuration information comprises M measurement Gap configurations, wherein M is a positive integer less than or equal to N;
receiving first indication information sent by the network side device, wherein the first indication information is configured to indicate that the terminal device performs mobility measurement; and
performing the mobility measurement according to the first indication information and the configuration information.

2. The measurement method according to claim 1, wherein the configuration information further comprises a default measurement Gap configuration, and performing the mobility measurement according to the first indication information and the configuration information comprises:
determining that the default measurement Gap configuration is a target measurement Gap configuration; and
performing the mobility measurement according to the first indication information and the target measurement Gap configuration.

3. The measurement method according to claim 1, wherein performing the mobility measurement according to the first indication information and the configuration information comprises:
determining that the M measurement Gap configurations are all target measurement Gap configurations;
receiving a first corresponding relationship, configured by the network side device, between the measurement Gap configurations and an SSB based RRM measurement timing configuration (SMTC) in a measurement object (MO);
determining a target SMTC in a target measurement object (MO) according to the target measurement Gap configurations and the first corresponding relationship; and
performing the mobility measurement according to the target measurement Gap configurations and the target SMTC.

4. The measurement method according to claim 1, wherein the first indication information indicates a target SMTC in a target measurement object (MO) for which the terminal device performing the mobility measurement, and performing the mobility measurement according to the first indication information and the configuration information comprises:
receiving a first corresponding relationship, configured by the network side device, between an SMTC in a measurement object (MO) and the measurement Gap configurations;
determining a target measurement Gap configuration from the M measurement Gap configurations according to the target SMTC and the first corresponding relationship; and
performing the mobility measurement according to the target measurement Gap configuration and the target SMTC.

5. The measurement method according to claim 1, further comprising:
reporting second indication information of the terminal device to the network side device, wherein the second indication information is configured to indicate that the network side device updates the measurement Gap configurations; and
receiving updated measurement Gap configurations configured by the network side device according to the second indication information.

6. The measurement method according to claims 3, further comprising:
reporting third indication information of the terminal device to the network side device, wherein the third indication information is configured to indicate that the network side device updates the measurement Gap configurations and the first corresponding relationship; and
receiving updated measurement Gap configurations and a second corresponding relationship which are configured by the network side device according to the third indication information.

7. A measurement method, executed by a network side device, comprising:
receiving capability indication information reported by a terminal device, wherein the capability indication information indicates that the terminal device supports simultaneous configuration of N measurement Gaps, and N is a positive integer;
sending configuration information to the terminal device, wherein the configuration information is configured by the network side device according to the capability indication information, and the configuration information comprises M measurement Gap configurations, wherein M is a positive integer less than or equal to N; and
sending first indication information to the terminal device, wherein the first indication information is configured to indicate that the terminal device performs mobility measurement.

8. The measurement method according to claim 7, wherein the configuration information further comprises a default measurement Gap configuration.

9. The measurement method according to claim 7, further comprising:
configuring a first corresponding relationship between the measurement Gap configurations and an SMTC in a measurement object (MO).

10. The measurement method according to claim 7, further comprising:
configuring a first corresponding relationship between an SMTC in a measurement object (MO) and the measurement Gap configurations.

11. The measurement method according to claim 7, further comprising:
receiving second indication information reported by the terminal device, wherein the second indication information is configured to indicate that the network side device updates the measurement Gap configurations; and
configuring updated measurement Gap configurations according to the second indication information.

12. The measurement method according to claim 9, further comprising:
receiving third indication information reported by the terminal device, wherein the third indication information is configured to indicate that the network side device updates the measurement Gap configurations and the first corresponding relationship; and
configuring updated measurement Gap configurations and a second corresponding relationship according to the third indication information.

13. (canceled)

14. (canceled)

15. A communication apparatus, comprising a processor and a memory, wherein the memory stores a computer program, and the processor executes the computer program stored in the memory to cause the communication apparatus to implement:
reporting capability indication information of a terminal device to a network side device, wherein the capability indication information is configured to indicate that the terminal device supports simultaneous configuration of N measurement Gaps, and N is a positive integer;
receiving configuration information sent by the network side device, wherein the configuration information is configured by the network side device according to the capability indication information, and the configuration information comprises M measurement Gap configurations, wherein M is a positive integer less than or equal to N;
receiving first indication information sent by the network side device, wherein the first indication information is configured to indicate that the terminal device performs mobility measurement; and
performing the mobility measurement according to the first indication information and the configuration information.

16. A communication apparatus, comprising: a processor and an interface circuit, wherein
the interface circuit is configured to receive code instructions and transmitting the same to the processor; and
the processor is configured to run the code instructions so as to execute the measurement method according to claim 1.

17. A non-transitory computer readable storage medium, configured to store instructions, wherein the instructions, when executed, cause the measurement method according to claim 1 to be implemented.

18. The communication apparatus according to claim 15, wherein the configuration information further comprises a default measurement Gap configuration, and the processor executes the computer program stored in the memory to cause the communication apparatus to implement:
determining that the default measurement Gap configuration is a target measurement Gap configuration; and
performing the mobility measurement according to the first indication information and the target measurement Gap configuration.

19. The communication apparatus according to claim 15, the processor executes the computer program stored in the memory to cause the communication apparatus to implement:
determining that the M measurement Gap configurations are all target measurement Gap configurations;
receiving a first corresponding relationship, configured by the network side device, between the measurement Gap configurations and an SSB based RRM measurement timing configuration (SMTC) in a measurement object (MO);
determining a target SMTC in a target measurement object (MO) according to the target measurement Gap configurations and the first corresponding relationship; and
performing the mobility measurement according to the target measurement Gap configurations and the target SMTC.

20. A communication apparatus, comprising a processor and a memory, wherein the memory stores a computer program, and the processor executes the computer program stored in the memory to cause the communication apparatus to execute the measurement method according to claim 7.

21. A communication apparatus, comprising: a processor and an interface circuit, wherein
the interface circuit is configured to receive code instructions and transmitting the same to the processor; and
the processor is configured to run the code instructions so as to execute the measurement method according to claim 7.

22. A non-transitory computer readable storage medium, configured to store instructions, wherein the instructions, when executed, cause the measurement method according to claim 7 to be implemented.
